(19) United States
(12) Patent Application Publication
(10) Pub. No.: US 2009/0121191 A1
(43) Pub. Date: May 14, 2009

(54) System and method for high pressure synthesis gas processing

(75) Inventor: Thomas Tillman, Sugar Land, TX (US)

Correspondence Address: CONLEY ROSE, P.C.;David A. Rose, P. O. BOX 3267, HOUSTON, TX, 77253-3267, US

(73) Assignee: Texyn Hydrocarbon, LLC, Houston, TX (US)

(21) Appl. No.: 12/271,010

(22) Filed: Nov. 14, 2008

Related U.S. Application Data
(60) Provisional application No. 60/987,842, filed on Nov. 14, 2007.

(51) Int. Cl. C01B 3/38; B01J 10/00; C01B 31/20; C01B 21/00

(52) U.S. Cl. 252/373; 422/187; 423/437.1; 423/359; 423/365

(57) ABSTRACT

A system for production of CO₂-rich product gas, the system including a steam shift reactor for production of shifted synthesis gas from high pressure raw synthesis gas; a hydrogen separation unit to separate the shifted synthesis gas into a hydrogen-rich product comprising a greater volume percentage of hydrogen than the shifted synthesis gas and a hydrogen-lean tailgas comprising a reduced volume percentage of hydrogen than the shifted synthesis gas; an oxidizing unit adapted to oxidize the hydrogen-lean tailgas with purified oxygen comprising primarily oxygen, to produce an oxidized product gas comprising water vapor and carbon dioxide; and dehydration apparatus adapted for removal of water vapor from the oxidized product gas to provide CO₂-rich product gas comprising at least 95% CO₂ by volume; wherein the proportional critical temperature of the CO₂-rich product gas is near or greater than the critical temperature of pure CO₂.

### CROSS-REFERENCE TO RELATED APPLICATIONS

This application claims the benefit under 35 U.S.C. §119(e) of U.S. Provisional Patent Application Ser. No. 60/987,842 filed Nov. 14, 2007, which is hereby incorporated herein by reference in its entirety.

### FIELD OF THE INVENTION

The disclosure relates generally to systems and methods of processing high-pressure synthesis gas. More specifically, the disclosure relates to systems and methods of producing a carbon dioxide-rich product from high pressure synthesis gas. Still more specifically, the disclosure relates to systems and methods of producing, from high pressure synthesis gas, a carbon dioxide-rich product suitable for use in sequestration including enhanced oil recovery operations.

### BACKGROUND

Gas comprising a mixture of hydrogen (H₂) and carbon monoxide (CO) is commonly referred to as “synthesis gas” or “syngas.” Conventionally, steam reforming of fossil fuels such as natural gas is utilized to produce synthesis gas (syngas). Synthesis gas may be generated by solids gasification (gasification of coal, biomass, or other bio-renewables), by steam or dry reforming of natural gas or liquid hydrocarbons, or partial oxidation of natural gas or liquid hydrocarbons. The relative amounts of CO and H₂ in a synthesis gas product varies depending upon the way it is generated.

The synthesis gas produced is generally a “sour” gas comprising sulfurous components such as hydrogen sulfide (H₂S). Generally, following production of synthesis gas, sweetening processes known as acid gas removal (AGR) are utilized to remove undesirable components from the synthesis gas. For example, amine gas treating, also known as gas sweetening and acid gas removal, are a group of processes that are used to remove hydrogen sulfide (H₂S) and carbon dioxide (CO₂) from gases via contact with aqueous solutions of various amines. Processes within oil refineries or (natural) gas processing plants that remove hydrogen sulfide and/or mercaptans are commonly referred to as “sweetening” processes because the products created no longer have the sour, foul odors of mercaptans and hydrogen sulfide.

AGR systems typically use chemical solvents and/or physical solvents, which remove H₂S and CO₂ from the raw synthesis gas. These solvents may be one of many forms of amines, or proprietary systems such as Selexol® commercially licensable from UOP, LLC of Des Plaines, Ill. or Rectisol® commercially licensable from Lurgi AG of Frankfurt, Germany. There are many other variations of AGR systems; however such systems are typically capital-intensive, and require substantial energy to operate. The AGR process is generally not affected by the fact that the synthesis gas is a “reducing” environment (as opposed to an “oxidizing” environment). The AGR process does, however, utilize “flash” removal of contaminants from the solvent, at low pressure, in a separate, heated regeneration vessel. This lower pressure mandates expensive recompression of gaseous products for further treatment or for pipeline duty. The regeneration process also requires significant heat energy prior to the flash removal of contaminants.

Although there are many alternative systems and processes for removing sulfur from gases, many of these alternative, lower-costs systems typically involve the use of an oxidant, and are not operable in a reducing environment. There are, however, alternative forms of sulfur washing from gases that do perform well in a reducing environment. For example, the Lo-Cat® Process and the Sulferox® Process which utilize solutions of chelated iron; and the Stretford® Process, which utilizes anthraquinone disulfonic acid (ADA) chemistry. These processes involve utilization of liquid solutions that are regenerated in a separate oxidizing process vessel, not resulting in a loss of product pressure. These acceptable sulfur washing systems are generally classified as Hot Gas Clean Up (HGCU) or Warm Gas Clean Up (WGCU). The terms ‘H₂S wash’, ‘hot gas clean-up’ and ‘warm gas clean-up’ can be used interchangeably.

Hydrogen (H₂) is an attractive alternative to fossil fuels as a non-polluting source of energy, and it is also a valuable commodity, for example for use in product upgrading such as hydrocracking and hydroisomerizing liquid hydrocarbons to produce desirable products. Existing technologies for separating and purifying the hydrogen component of synthesis gas usually involve pressure swing adsorption (PSA), membrane separation, or chemical reaction on solid iron oxide and calcium oxide beds, with regeneration of the solids.

Enhanced Oil Recovery (EOR) is a generic term for techniques utilized for increasing the amount of oil extracted from an oil field. Enhanced oil recovery is also called improved oil recovery or tertiary recovery, and increases the amount of oil removed from an oil field over that extracted using primary and secondary recovery alone. Improved extraction may be attained by gas injection, chemical injection, or thermal recovery.

The most widely used EOR technique is gas injection, whereby gas such as carbon dioxide (CO₂), nitrogen, or natural gas is injected into a reservoir. Desirable components of gases utilized for miscible enhanced oil recovery have critical temperatures around or above that of pure carbon dioxide (304 K; 31° C.). The injected gas expands, pushing additional oil towards and into a production wellbore. The injected gas also dissolves in the oil, lowering the viscosity of the oil phase and thereby improving the flow rate of the oil within the reservoir/well. The injected gas also selectively fills the “pore volume” of the oil field, i.e., the interstitial space between sand grains.

There is a need in the industry for systems and methods of producing, from high pressure synthesis gas, valuable products such as carbon dioxide-rich gas suitable for sequestration and high purity hydrogen gas suitable for use as fuel or in product upgrading.

### BRIEF SUMMARY OF SOME OF THE PREFERRED EMBODIMENTS

In accordance with certain embodiments of the invention, a system is provided for production of a CO₂-rich product gas, the system comprising: a steam shift reactor adapted for the production of shifted synthesis gas from a high pressure raw synthesis gas, wherein the shifted synthesis gas comprises hydrogen and carbon dioxide produced by reaction of steam with carbon monoxide in the raw synthesis gas; a hydrogen separation unit adapted to separate the shifted synthesis gas into a hydrogen-rich product comprising a greater volume percentage of hydrogen than the shifted synthesis gas and a hydrogen-lean tailgas comprising a reduced volume percentage of hydrogen than the shifted synthesis gas; an oxidizing unit adapted to oxidize the hydrogen-lean tailgas with purified oxygen comprising primarily oxygen, to produce an oxidized product gas comprising water vapor and carbon dioxide; and dehydration apparatus adapted for removal of water vapor from the oxidized product gas to provide CO₂-rich product gas comprising at least 95% CO₂ by volume; wherein the proportional critical temperature of the CO₂-rich product gas is near or greater than the critical temperature of pure CO₂. In applications, the system does not comprise an acid gas removal unit. The purified oxygen may comprise at least 95% or at least 99% by volume pure oxygen. The CO₂-rich product gas may be suitable for use in enhanced oil recovery or other CO₂ sequestration processes. The system may further comprise heat recovery apparatus whereby the heat produced in the oxidizing unit is captured by the heat recovery apparatus. In embodiments, the dehydration apparatus dehydrates by cooling the oxidized product gas and condensing the water vapor therein. The disclosed system may comprise a hot gas clean-up or warm gas clean-up unit positioned upstream of the steam shift reactor and adapted to provide H₂S removal from the raw synthesis gas. In applications, the system comprises a plurality of steam shift reactors and a plurality of hydrogen separation units, wherein at least one hydrogen separation unit downstream of one of the steam shift reactors is paired therewith via an intervening re-humidification unit. The hydrogen separation unit may comprise at least one selected from physical separation membranes, zeolites, ceramic filters, and transport separation membranes. The hydrogen removal unit may be integrated with the steam shift reactor.

In applications, the oxidizing unit is selected from thermal oxidizers, and partial oxidation reactors adapted for high pressure operation. The partial oxidation reactor may be adapted for internal steam generation. The system may comprise a steam generation unit downstream of the oxidizing unit. In some applications, the system comprises a steam generation unit downstream of the oxidizing unit and the oxidizing unit is adapted for internal steam generation. A line may be provided for introducing steam from the oxidizing unit, the downstream steam generation unit, or both into the steam shift reactor.

The system may further comprise at least one contaminant removal unit downstream the oxidizing unit, wherein the at least one contaminant removal unit is adapted to remove at least one selected from the group consisting of sulfur compounds, nitrogen compounds, mercury, and heavy metals, from the oxidized product gas. The at least one contaminant removal unit may be selected from the group consisting of zeolite beds and activated carbon beds.

Also disclosed is a system for the production of a CO₂-rich product gas suitable for use in CO₂-sequestration processes from a high pressure raw synthesis gas, the system comprising: apparatus that is configured to remove compounds having nominal critical temperatures below the critical temperature of pure carbon dioxide and leave behind compounds having nominal critical temperatures at least as high as the critical temperature of pure carbon dioxide.

Also disclosed is a method of producing CO₂-rich product gas, the method comprising: introducing steam and a high pressure raw synthesis gas into at least one steam shift reactor to produce a shifted synthesis gas comprising a greater volume percentage of hydrogen and carbon dioxide than the raw synthesis gas, wherein the steam shift reactor comprises catalyst effective for catalyzing the production, via water-gas shift, of hydrogen and carbon dioxide from the steam and at least a portion of the carbon monoxide in the raw synthesis gas; removing a hydrogen-rich product from the shifted synthesis gas to produce a hydrogen-lean tailgas; oxidizing the resulting hydrogen-lean tailgas by contacting the hydrogen-lean tailgas in with purified oxygen to produce an oxidized product gas comprising primarily carbon dioxide and water vapor; and removing water vapor from the oxidized product gas to produce CO₂-rich product gas having a proportional critical temperature near to or greater than the critical temperature of pure carbon dioxide and comprising at least 95% CO₂ by volume. Removing hydrogen from the shifted synthesis gas may comprise introducing the shifted synthesis gas into a pressure swing adsorption (PSA) system or a membrane system. The CO₂-rich product gas may be suitable for enhanced oil recovery or other CO₂ sequestration operations. The CO₂-rich product gas may have a pressure greater than the minimum miscibility pressure required for enhanced oil recovery. The CO₂-rich product gas may have a pressure greater than about 2,200 psi (15.2 MPa), and be suitable for CO₂ transport pipelines. The pressure of the CO₂-rich product gas may be above the critical pressure.

In applications, the method further comprises extracting thermal energy from the oxidized product gas. Extracting thermal energy may comprise steam generation. Removing water vapor from the oxidized product gas may comprise cooling and/or dehydrating the oxidized product gas.

The oxidized product gas may be contacted with at least one absorbent to assist in removal of at least one selected from water-soluble gases including nitrogen compounds and sulfur compounds and water-soluble salts or compounds to produce remaining gas. The remaining gas may be treated to transform non-soluble mercury therein into soluble mercury.

In embodiments, the amount of CO₂ captured via the disclosed method exceeds 90%. In embodiments, the amount of CO₂ captured via the disclosed method exceeds 99%. In embodiments, the amount of CO₂ captured via the disclosed method exceeds 99.9%.

The purified oxygen may be produced in an air separation reactor, providing a nitrogen-rich product gas, and the method may further comprise producing ammonia from the nitrogen-rich product gas and hydrogen removed from the shifted synthesis gas. Urea may be produced from the ammonia.

The method may further comprise reacting at least a portion of the carbon dioxide in the CO₂-rich product gas and at least a portion of the hydrogen in the hydrogen-rich product in the presence of suitable shift catalyst to produce a second shifted product gas comprising carbon monoxide and steam, removing water vapor from the second shifted product, and combining with a second portion of hydrogen in the hydrogen-rich product to produce recreated synthesis gas having a desired mole ratio of hydrogen to carbon monoxide. The desired mole ratio may be a mole ratio suitable for the synthesis of methane, methanol, mixed alcohols, Fischer-Tropsch (FT) liquids, or other hydrocarbons from the recreated synthesis gas.

Also disclosed is a method of producing hydrogen-rich product gas and energy from high pressure raw synthesis gas, the method comprising: introducing steam and a high pressure raw synthesis gas into at least one steam shift reactor to produce a shifted synthesis gas comprising more hydrogen and carbon dioxide than the raw synthesis gas, wherein the steam shift reactor comprises catalyst effective for catalyzing the production, via water-gas shift, of hydrogen and carbon dioxide from the steam and at least a portion of the carbon monoxide in the raw synthesis gas; removing a hydrogen-rich product gas from the shifted synthesis gas to produce a hydrogen-lean tailgas; oxidizing the resulting hydrogen-lean tailgas by contacting the hydrogen-lean tailgas in with purified oxygen to produce an oxidized product gas comprising primarily carbon dioxide and water vapor; and introducing the oxidized product gas into a high-pressure gas expander coupled to a generator whereby the oxidized product gas is expanded to near atmospheric pressure and energy is recovered. The method may further comprise introducing the low pressure tail gas into an atmospheric pressure heat recovery steam generator to recover further energy from steam generation.

Elimination of AGR, of product and/or CO₂ compressors, and/or of contaminant handling systems may lead towards a simple and less expensive means of capturing CO₂. The system and method may provide for simplified hydrogen production and capture, resulting in low-cost hydrogen fuel.

Thus, embodiments described herein comprise a combination of features and advantages intended to address various shortcomings associated with certain prior systems and processes. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 is a schematic depicting possible zones of an embodiment of a high pressure synthesis gas processing system in accordance with the principles described herein.

FIG. 2 is a schematic of an embodiment of a high pressure synthesis gas processing system in accordance with the principles described herein.

FIG. 3 is a schematic of an embodiment of a conversion/extraction zone in accordance with the principles described herein.

FIG. 4 is a schematic of an embodiment of a WGCU system in accordance with the principles described herein.

FIG. 5 is a schematic of an embodiment of an oxy-fuel burner system in accordance with the principles described herein.

FIG. 6 is a schematic of an embodiment of a high pressure product enhancement/utilization zone in accordance with the principles described herein.

### DETAILED DESCRIPTION

### Overview

Herein disclosed are embodiments of a system and method for producing valuable product from high pressure synthesis gas; such products include high pressure carbon dioxide-rich gas suitable for sequestration operations and hydrogen suitable for use as fuel, product upgrading gas, or other use.

One goal of the disclosed embodiments is to capture high pressure CO₂, desirably at elevated concentrations. By utilizing a very high-pressure raw synthesis gas, and by expeditiously controlling the loss of pressure throughout the system, a CO₂-rich gas may be obtained which has a desired residual pressure. For example, in select applications, the residual pressure of the CO₂-rich product gas is greater than the critical pressure of CO₂ (1,070 psi; 7.4 MPa). The critical pressure of CO₂ is less than the critical pressures of SO₂ (1,143 psi; 7.9 MPa) and NO₂ (1,470 psi; 10.1 MPa). The injection pressure of CO₂ in enhanced oil recovery is typically about 1500 psi (10.3 MPa), which is greater than the critical pressure of an EOR gas containing not only CO₂, but also measurable amounts of SO₂ and NO₂. Such a product gas at a pressure greater than about 1500 psi (10.3 MPa) is suitable for EOR operations, and this residual pressure exceeds the minimum miscibility pressure of the EOR gas in oil in many instances. Even more desirably, the disclosed system and method may be utilized to produce a product CO₂-rich gas at a residual pressure of greater than about 2,200 psi (15.2 MPa), which is a typical pressure rating for long-distance CO₂ transport pipelines.

To capture high pressure carbon dioxide gas, energy is extracted from the high pressure raw (or feed) synthesis without removing carbon compounds, i.e. extracting fuel gas as CO or CH₄ is undesirable. The systems and methods are designed, therefore, for extraction of usable chemical energy from the synthesis gas in the form of hydrogen. Because the high pressure synthesis gas feed may comprise approximately equimolar amounts of carbon monoxide and hydrogen, the CO will be “shifted” in a steam shift catalyst system. Such a steam shift catalyst system converts carbon monoxide to additional carbon dioxide via reaction with steam, also creating more hydrogen gas.

The disclosed embodiments involve shifting the high pressure raw synthesis gas prior to points where traditional acid gas removal (AGR) systems could successfully be used. The process may be a “sour shift”, because there may still be sulfur contaminants in the high pressure raw synthesis gas. Sour shift may also serve to transform most of the carbonyl sulfide in the synthesis gas to hydrogen sulfide.

The disclosed embodiments remove hydrogen from the ‘dirty’ high pressure synthesis gas up front, leaving the greater portion of the contaminants behind. This is counterintuitive and contrary to traditional systems and methods which generally operate by upfront removal of undesirables such as H₂S and CO₂ from a dirty synthesis gas, e.g. by means of an AGR, leaving the desirable elements behind.

Undesirable compounds for inclusion in an EOR gas will be considered as a compound having a critical temperature below the critical temperature of pure CO₂, i.e. about 88° F. (304 K). Table 1 shows critical temperatures of various gaseous compounds. Hydrogen (H₂), nitrogen (N₂), oxygen (O₂), carbon monoxide (CO), and methane (CH₄) each have much lower critical temperatures than pure CO₂. These compounds would negatively influence EOR performance by typically raising the minimum miscibility pressure of the EOR gas. On the other hand, NO₂ and SO₂ have higher critical temperatures than pure CO₂, and inclusion thereof in an EOR gas may desirably reduce the minimum miscibility pressure of the EOR gas, when present in limited quantities.

TABLE 1
Critical Temperatures of Various Gaseous Components

| | Formula | Critical Temperature, K |
|---|---|---|
| Undesirable EOR Compounds | | |
| Hydrogen | H₂ | 33 |
| Nitrogen | N₂ | 126 |
| Carbon monoxide | CO | 132 |
| Oxygen | O₂ | 155 |
| Nitrogen Oxide | NO | 180 |
| Methane | CH₄ | 191 |
| Desirable/Acceptable EOR | | |
| Compounds | | |
| Carbon dioxide | CO₂ | 304 |
| Nitrous Oxide | N₂O | 310 |
| Hydrogen Sulfide | H₂S | 325 |
| | | (correlation) |
| Hydrogen Sulfide | H₂S | 373 |
| | | (actual) |
| Carbonyl Sulfide | COS | 375 |
| Ammonia | NH₃ | 405 |
| Sulfur Dioxide | SO₂ | 430 |
| Nitrogen Dioxide | NO₂ | 431 |
| Hydrogen Cyanide | HCN | 457 |

While the actual critical temperature of H₂S is about 373 K (211.7° F.), the corrected critical temperature of H₂S, as a correlation of its minimum miscibility pressure is about 325 K (125.3° F.), as per SPE-12468, published in the Journal of Petroleum Technology, November 1985, “Correlation of Minimum Miscibility Pressure for Impure CO₂ Streams”, authored by Sebastian et al, of Amoco Production Co.

### I. System

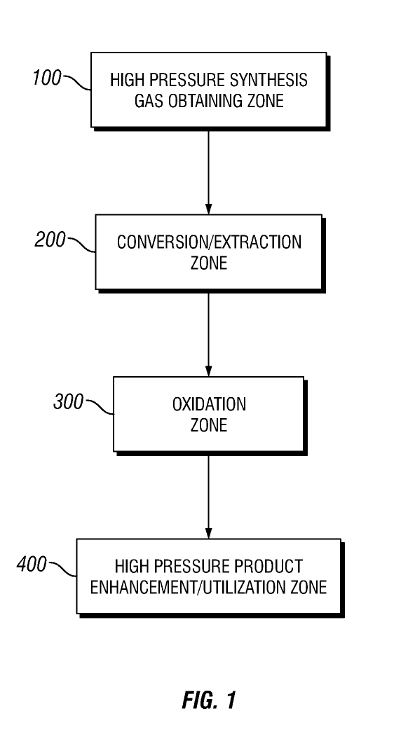

FIG. 1 is a schematic depicting possible zones of a high pressure synthesis gas processing system according to embodiments described herein. The high pressure synthesis gas processing system comprises a conversion/extraction zone 200 for converting carbon monoxide in a high pressure synthesis gas into additional carbon dioxide and hydrogen via steam water gas shift reaction, and an oxidation zone 300 for oxidizing components considered undesirable from an EOR viewpoint (i.e., components having critical temperatures below that of carbon dioxide) into more desirable components from an EOR viewpoint. The disclosed high pressure processing system may further comprise a high pressure synthesis gas obtaining zone 100 upstream of conversion/extraction zone 200 and adapted for producing and/or providing a suitable high pressure synthesis gas to conversion/extraction zone 200. The disclosed high pressure processing system may also further comprise a high pressure product utilization/enhancement zone 400 downstream of oxidation zone 300 and configured for upgrading and/or utilizing the high pressure CO₂-rich product from oxidation zone 300.

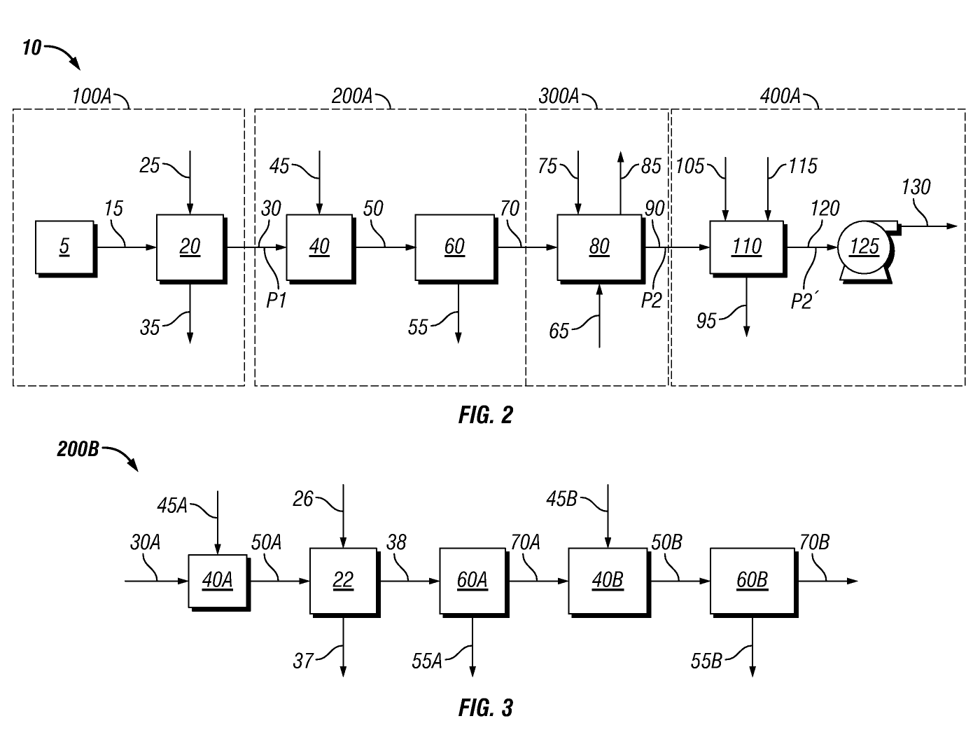

FIG. 2 is a schematic of a high pressure synthesis gas processing system 10 (also referred to herein as “high pressure system 10” or simply “system 10”) according to an embodiment of this disclosure. High pressure synthesis gas processing system 10 comprises high pressure synthesis gas obtaining zone 100A, conversion/extraction zone 200A, oxidation zone 300A, and high pressure product enhancement/utilization zone 400.

### High Pressure Synthesis Gas Obtain in a Zone 100

As mentioned hereinabove, embodiments of the high pressure synthesis gas processing system disclosed herein may comprise a high pressure synthesis gas obtaining zone 100. High pressure synthesis gas obtaining zone 100 is configured for producing and/or providing suitable high pressure synthesis gas to conversion extraction zone 200. Suitable high pressure synthesis gas has a pressure greater than or equal to the critical pressure of carbon dioxide plus the pressure drops across conversion/extraction zone 200, and oxidation zone 300, and, when present, high pressure product enhancement/utilization zone 400, such that the high pressure CO₂-rich product gas extracted from oxidation zone 300 or, when present, high pressure product enhancement/utilization zone 400, has a proportional critical temperature near to or greater than the critical temperature of pure carbon dioxide.

In the embodiment of FIG. 2, high pressure synthesis gas obtaining zone 100A comprises gasification system 5 and cleaning and/or quench apparatus 20.

### Gasification System 5

In the embodiment of FIG. 2, high pressure synthesis gas obtaining zone 100A comprises gasification system 5 for the production of synthesis gas having a sufficiently high pressure that the resulting product CO₂-rich gas exiting oxidation zone 300A or, when present, high pressure product enhancement/utilization zone 400A, has a residual pressure above a desired value. Most standard gasifiers are not designed for production of such high pressure synthesis gas, typically being limited to standard pressures of about 500 psi to 1,000 psi (3.4 MPa to 6.9 MPa). New commercially-available gasifiers are available at pressure ratings of 1,250 psi (8.6 MPa), and special gasifiers with pressure ratings greater than 2,000 psi (13.8 MPa) are known.

To obtain a raw synthesis gas having the desired high pressure, gasification system 5 may comprise an underground coal gasification system. The underground coal gasification system (UCG) may comprise one or more plasma gasifiers. In embodiments, high pressure synthesis gas processing system 10 comprises an underground coal gasification system as described in U.S. patent application Ser. No. 12/056,960, filed Mar. 27, 2008 and entitled, “System and Method for Recovery of Fuel Products from Subterranean Deposits via an Electric Device,” the disclosure of which is hereby incorporated herein by reference to the extent it provides procedural or other details consistent with and supplementary to those set forth herein.

Inlet line 30 connects conversion/extraction zone 200A with a source of high pressure synthesis gas, such as gasification system 5. The high pressure synthesis gas may be obtained from gasification of carbonaceous materials, as mentioned above. Suitable synthesis gas for use in the disclosed system comprises hydrogen and carbon monoxide, and has a high pressure. As discussed further hereinbelow, additional processing apparatus may be positioned downstream of gasification system 5, such that the raw synthesis gas produced in gasification system 5 may undergo further processing prior to introduction into conversion/extraction zone 200B via inlet line 30.

The raw synthesis gas may have approximately a mole ratio of hydrogen to carbon monoxide in the range of from about 1:1 to about 2:1. In applications, the raw synthesis gas has a mole ratio of hydrogen to carbon monoxide of about 1:1. In embodiments, the raw synthesis gas comprises from about 40-60% hydrogen by volume, from about 30-50% CO by volume, less than about 5% CO₂ by volume, and less than about 10% H₂O by volume. Unless otherwise indicated, percentages provided herein are on a volume basis.

The pressure P1 of the raw synthesis gas provided to conversion/extraction zone 200A by inlet line 30 is greater than the critical pressure of CO₂, which is about 1,070 psi (7.4 MPa), plus a margin for pressure drop along the system such that the residual pressure P2, P2′ of the CO₂-rich product gas extracted via oxidized product gas outlet line 90 or dehydrated product gas outlet line 120, respectively, is greater than a desired value. The desired value may be the critical pressure of CO₂ (1,070 psi; 7.4 MPa); more preferably, the desired pressure is greater than the typical injection pressure of oil to be removed via EOR utilizing the product CO₂-rich gas (1,500 psi, 10.4 MPa); still more preferably, the residual pressure of the CO₂-rich product gas is greater than about 2,200 psi (15.2 MPa), which is a typical pressure rating for long-distance CO₂-transport pipelines.

In embodiments, inlet line 30 connects conversion/extraction zone 200A with a source of raw synthesis gas having a pressure rating of at least about 2,000 psi (13.8 MPa) such that the residual pressure P2 of the CO₂-rich product gas extracted from oxidation zone 300 and, when present, the residual pressure P2′ of CO₂-rich product gas extracted from high pressure product enhancement/utilization zone 400, is greater than 1,500 psi (10.3 MPa). In embodiments, inlet line 30 connects conversion/extraction zone 200A with a source of raw synthesis gas having a pressure rating of at least about 2,500 psi (17.2 MPa), such that the residual pressure of the CO₂-rich product gas extracted from system 10 is greater than 2,200 psi (15.2 MPa). As discussed hereinbelow, the source of high pressure raw synthesis gas may be an underground coal gasification system which converts very deep (e.g., stranded) coal into very high pressure synthesis gas.

The synthesis gas (syngas) would be theoretically ideal if it were composed only of hydrogen (H₂) and carbon monoxide (CO), perhaps in concentrations of 50% each, or perhaps in mole ratios of 1:2 to 2:1. However in reality, the synthesis gas may also contain carbon dioxide (CO₂), methane (CH₄), steam (H₂O), sulfur contaminants such as hydrogen sulfide (H₂S) and carbonyl sulfide (COS), nitrogen contaminants such as nitrogen gas (N₂), ammonia (NH₃), and hydrogen cyanide (HCN), or a combination thereof. Furthermore, the synthesis gas may further comprise small amounts of gaseous contaminants resulting from other contaminants in the original carbonaceous fuel, such as mercury, calcium, and chlorine.

The synthesis gas may comprise nitrogen and nitrogen-containing compounds. Such nitrogen and nitrogen-containing compounds may be found in the raw synthesis gas for one or both of at least two reasons. The first source is fuel-bound nitrogen, which enters with the fuel gasified to produce the synthesis gas. A second source of nitrogen and nitrogen-containing compounds is nitrogen contamination of the “blast” medium of the gasification process, which is usually air or concentrated oxygen. For the purposes of this description, purified oxygen will be assumed as the blast medium. In various applications, however, gasification system 5 may not use a blast medium, for example in pyrolysis reactors and plasma systems; nonetheless, the high pressure synthesis gas may comprise some amount of nitrogen or nitrogen-containing compounds, e.g. from fuel-bound nitrogen.

The high pressure synthesis gas may also comprise more complex hydrocarbons, such as tars, phenols, and aromatic compounds. Such compounds may be present in the synthesis gas when the gasification reaction is operated at a temperature that is too low to destroy pyrolysis products. Desirably, such products are not present because the synthesis gas is produced by gasification at high enough temperature that such compounds are substantially eliminated. Should such compounds be present in the available synthesis gas from gasification, high pressure system 10 may further comprise apparatus for the removal thereof. Desirably, inlet line 30 connects conversion/extraction zone 200A with a source of synthesis gas that is clean of particulates or liquids. High pressure system 10 may further comprise gas cleaning and/or quench apparatus 20 for cleaning the high pressure raw synthesis gas of gross contaminants.

Cleaning and/or Quench Apparatus 20

High pressure synthesis gas processing system 10 may further comprise cleaning or quench apparatus 20 downstream of gasification system 5. Such cleaning or quench apparatus 20 may be within high pressure synthesis gas obtaining zone 100 and/or conversion/extraction zone 200. As depicted in the embodiment of FIG. 2, cleaning or quench apparatus 20 is upstream of shift reactor 40 and coupled to gasification system 5 via line 15. Alternatively or additionally, a cleaning or quench apparatus 20 may be positioned downstream of shift reactor 40 within conversion/extraction zone 200. Cleaning or quench apparatus 20 may be configured to reduce the temperature of the high pressure synthesis gas and/or remove gross contaminants therefrom. In embodiments, gas cleaning or quench apparatus 20 comprises at least one selected from quench scrubbers, candle filters, water-tube and fire-tube steam generators, and combinations thereof. Gas cleaning or quench apparatus 20 may comprise any other suitable means of cleaning the raw synthesis gas of gross contaminants prior to introduction into shift reactor 40. For example, gas cleaning or quench apparatus 20 may be adapted to reduce the temperature of high pressure raw synthesis gas introduced thereto via line 15, e.g. from gasification system 5, to a temperature suitable for introduction into shift reactor 40. A quench water supply line 25 and waste water outlet line 35 may be connected to gas cleaning or quench apparatus 20 to introduce water thereto and to remove wastewater therefrom, respectively.

### Conversion/Extraction Zone 200

The high pressure synthesis gas processing system of this disclosure comprises a conversion/extraction zone 200 for the conversion of carbon monoxide in a high pressure raw synthesis gas into additional carbon dioxide and hydrogen via steam water gas shift. Conversion/extraction zone 200 comprises at least one reactor for carrying out water gas shift and one reactor for carrying out hydrogen separation. The at least one reactor for carrying out water gas shift and the at least one reactor for carrying out hydrogen separation may be a single unit adapted for carrying out the water gas shift reaction and removing hydrogen from the shifted product.

In the embodiment of FIG. 2, conversion/extraction zone 200A of high pressure synthesis gas processing system 10 comprises shift or sour shift reactor 40 and hydrogen separation unit 60. Shift reactor 40 is fluidly connected via an inlet line 30 to a source of high pressure synthesis gas within high pressure synthesis gas obtaining zone 100A and via shifted product outlet line 50 to hydrogen separation unit 60. Shift reactor 40 is connected to a steam inlet line 45 for introducing water and/or steam into shift reactor 40. Although shown as a single vessel, shift reactor 40 may be in contact with an optional steam humidification vessel immediately upstream of the shift reactor 40. In such instances, steam inlet line 45 may introduce steam into a steam humidification vessel upstream of shift reactor 40. Shift reactor 40 is fluidly coupled to hydrogen separation unit 60 by shifted product outlet line 50. Hydrogen separation unit 60 is fluidly connected with hydrogen-rich outlet line 55 for hydrogen-rich gaseous product and a hydrogen-lean outlet line 70 for hydrogen-lean tailgas.

The high pressure synthesis gas processing system may comprise a plurality of shift reactors 40 and hydrogen separation units 60. In embodiments, high pressure synthesis gas processing system 10 comprises two, three, or four shift reactors 40. In embodiments, high pressure synthesis gas processing system 10 comprises two, three, or four hydrogen separation units. For example, FIG. 3 is a schematic of a conversion/extraction zone 200B according to another embodiment of this disclosure. In the embodiment of FIG. 3, conversion/extraction zone 200B comprises first and second water gas shift reactors 40A and 40B, respectively, and first and second hydrogen separation units 60A and 60B, respectively. First shift reactor inlet line 30A connects a source of high pressure synthesis gas with first shift reactor 40A of conversion/extraction zone 200A. Steam inlet line 45A may introduce water and/or steam directly into first steam shift reactor 40A or into a humidification vessel upstream of first shift reactor 40A. A first shifted synthesis gas outlet line 50A connects first shift reactor 40A with warm gas clean up (WGCU) system 22. WGCU system 22 is connected to WGCU solution inlet line 26 for introducing a wash medium and a removal line 37 for removal of absorbed or entrained contaminants. A WGCU outlet line 38 connects WGCU system 22 with a first hydrogen separation unit 60A. First hydrogen separation unit 60A is fluidly connected to a first hydrogen-rich outlet line 55A for hydrogen-rich product and a first hydrogen lean outlet line 70A for hydrogen-lean tailgas. First hydrogen-lean outlet line 70A fluidly connects first hydrogen separation unit 60A with a second shift reactor 40B. Second shift reactor 40B comprises an inlet for steam connected to steam inlet line 45B and is fluidly connected with a second shifted synthesis gas outlet line 50B for second shifted product. As with first shift reactor 40A, steam inlet line 45B may introduce steam into a humidification vessel upstream of second shift reactor 40B. Second shifted synthesis gas outlet line 50B fluidly connects second shift reactor 40B with a second separation unit 60B. Second hydrogen separation unit 60B is fluidly connected with a second hydrogen-rich outlet line 55B for hydrogen-rich product and a second hydrogen-lean outlet line 70B for CO₂-rich product.

### Shift Reactor 40

Shift reactors 40, 40A, 40B may be any reactor known for shifting a high pressure synthesis gas stream containing carbon monoxide such that additional hydrogen and carbon dioxide is produced from steam and carbon monoxide in the synthesis gas stream via the water gas shift reaction:

CO+H₂O [symbol] CO₂+H₂. (1)

This reaction is slightly exothermic, and will generate heat. A gas cooler may be positioned immediately downstream of the shift reactor(s) to lower the gas temperature to that temperature which the subsequent step requires.

Depending on the feed thereto, shift reactors may be considered sour or sweet. For example, shift reactors 40 and 40A may be sour shift reactors, while downstream shift reactors, e.g. shift reactor 40B, may be sweet shift reactors. The shift reactor may comprise a water gas shift catalyst, known in the art. The shift reactor may comprise two stages, one stage a high temperature shift, for example at about 350° C. (662° F.) and the second stage a low temperature shift, for example, at about 190-210° C. (374-410° F. Shift reactor 40 may comprise one or more shift catalyst. The catalyst may be selected from iron oxide promoted with chromium oxide for the high temperature shift stage and copper on a mixed support comprising zinc and aluminum oxide for the low temperature shift stage. In embodiments, the shift catalyst comprises Fe₃O₄ (magnetite) or other transition metals and transition metal oxides. In embodiments, the shift catalyst comprises Raney copper. Desirably, the steam shift catalyst is capable of converting most of the carbonyl sulfide (COS) into H₂S.

As mentioned with regard to FIG. 3, although depicted as a single unit in the embodiment of FIG. 2, the high pressure synthesis gas processing system of this disclosure may comprise a plurality of shift beds in a steam shift system. In such embodiments, steam may be added to the synthesis gas prior to introduction to each shift bed to maintain a desirable gas temperature and an H₂O:CO mole ratio suitable for the selected shift catalyst.

In applications, steam shift reactor 40, 40A, 40B is operable such that hydrogen-rich shifted synthesis gas product extracted from the shift reactor (e.g. via shifted product outlet line 50, first shifted synthesis gas outlet line 50A, second shifted synthesis gas outlet line 50B) comprises less than or equal to about 15% or less than or equal to about 15% by volume of the CO fed thereto (e.g., via inlet line 30, first shift reactor inlet line 30A, or first hydrogen-lean outlet line 70A).

### Hydrogen Separation Unit 60

Conversion/extraction zone 200 of the disclosed high pressure synthesis gas processing system also comprises at least one hydrogen separation unit 60. Hydrogen separation unit 60 may be positioned downstream of a sour shift reactor. For example, in the embodiment of FIG. 2, conversion/extraction zone 200A comprises hydrogen separation unit 60. Hydrogen separation unit 60 is fluidly connected with shift reactor 40 via shifted product outlet line 50. Hydrogen separation unit 60 is fluidly connected to hydrogen-rich outlet line 55 for a hydrogen-rich product stream and a hydrogen-lean outlet line 70 for a hydrogen-reduced synthesis gas stream. Hydrogen-reduced synthesis gas produced within hydrogen separation unit 60 is introduced into oxidation zone 300A via hydrogen-lean outlet line 70.

In the embodiment of FIG. 3, conversion/extraction zone 200B comprises first and second shift reactors 40A and 40B, respectively and first and second hydrogen separation units 60A and 60B, respectively. First hydrogen separation unit 60A is fluidly connected with first shift reactor 40A via first shifted synthesis gas outlet line 50A, WGCU system 22, and WGCU system outlet line 38. First hydrogen separation unit 60A is fluidly connected to first hydrogen-rich outlet line 55A for a hydrogen-rich product stream and first hydrogen-lean outlet line 70A for a hydrogen-reduced tailgas stream. Second hydrogen separation unit 60B is fluidly connected with second shift reactor 40B via second shifted synthesis gas outlet line 50B. Second hydrogen separation unit 60B is fluidly connected to second hydrogen-rich outlet line 55B for a hydrogen-rich product stream and second hydrogen-lean outlet line 70B for a second hydrogen-reduced tailgas stream. Hydrogen-reduced synthesis gas produced within second hydrogen separation unit 60B may be introduced into an oxidation reactor of oxidation zone 300, 300A via second hydrogen-lean outlet line 70B.

Because of the unique characteristics of the hydrogen molecule, particularly its small size and unique electrical characteristics, a majority of the hydrogen in the shifted hydrogen rich gas extracted from shift reactor(s) 40, 40A, 40B may be extracted from the shifted hydrogen-rich gas. Depending on the purity of the hydrogen product desired, hydrogen separation unit(s) 60, 60A, 60B may be operable to obtain a hydrogen-rich product comprising approximately 90% by volume pure hydrogen. In embodiments wherein high purity hydrogen is desired, e.g. for the purposes of making industrial-grade hydrogen or fuel-cell hydrogen, the hydrogen separation unit(s) may be configured to produce a hydrogen-rich product having a purity of greater than about 99% by volume; alternatively, greater than about 99.5%; alternatively, greater than about 99.9%. In applications for which hydrogen is intended for non-fuel cell power generation, the hydrogen separation unit(s) may be configured to produce a hydrogen-rich stream having a purity of at least about purity of 90%. The desired purity may be selected based on power generation emissions requirements and the levels of impurities in the fuel that such requirements permit. Lower purity requirements for hydrogen-rich product extracted via hydrogen-rich outlet line(s) 55, 55A, 55B may result in higher hydrogen quantity yields.

Most systems that physically remove hydrogen from the shifted synthesis gas introduced thereto will result in a loss of pressure, both in the hydrogen-rich product stream in hydrogen-rich outlet line(s) 55, 55A, 55B and in the hydrogen-lean “tail gas” extracted via hydrogen-reduced or hydrogen-lean outlet lines 70, 70A, 70B, 70C. Typical Pressure Swing Absorber (PSA) systems are generally limited in gross pressure to less than 450 psi, and may thus not be desirable for the high pressure syngas in this embodiment. Within the disclosed system it is desirable to maintain as high a gas pressure as possible throughout. Thus, hydrogen separation unit 60, 60A, 60B may be selected such that purity and quantity of the hydrogen-rich product extracted therefrom may be balanced against the desire to maintain a high pressure. Within high pressure synthesis gas processing system 10, multiple shift reactors may be included to achieve high hydrogen production. For example, high pressure system 10 may comprise multiple steps of membrane removal such that high hydrogen recovery and/or high hydrogen purity may be obtained.

Hydrogen separation unit 60, 60A, 60B may be any unit capable of removing hydrogen-rich product and hydrogen-reduced product from a high pressure shifted hydrogen-rich feed gas. Desirably, hydrogen separation unit 60, 60A, 60B is operable to maintain the pressure of the hydrogen-rich product extracted via hydrogen-rich outlet line 55, 55A, 55B in excess of about 400 psi (2.8 MPa); alternatively, greater than about 500 psi (3.4 MPa). Such pressures may be suitable in applications in which the hydrogen-rich product is intended for power generation purposes. In other embodiments, hydrogen separation unit 60, 60A, 60B is operable to maintain the pressure of the hydrogen-rich product extracted via hydrogen-rich outlet line 55, 55A, 55B in excess of about 800 psi (5.5 MPa); alternatively, greater than about 1,000 psi (6.9 MPa). Such pressures may be suitable in applications in which the hydrogen-rich product is intended for pipeline applications. Maintaining such high pressures may eliminate the need for expensive hydrogen compression systems.

Hydrogen separation unit 60, 60A, 60B may comprise at least one selected from pressure swing adsorption (PSA) units, zeolite systems, ceramic filters, physical membrane systems and transport membrane systems. PSA systems may not function properly at higher pressures.

High pressure system 10 may further comprise a secondary clean-up system for the hydrogen-rich product extracted from hydrogen separation unit 60, 60A, 60B. Such a secondary system may be adapted to further polish the hydrogen product, and to remove what little entrained moisture might exist, thus providing industrial grade hydrogen. Such a secondary system may also serve as a “guard bed” in case of contaminant break-through into the hydrogen pipeline.

Although shown as separate units in FIG. 2, a single integral unit may be adapted for shifting the synthesis gas to produce more hydrogen and for extracting the hydrogen therefrom. In applications, high pressure system 10 comprises one or more such combined shift/separation units. A plurality of such combined shift/separation units may be aligned in series.

### WGCU System 22

As depicted in the embodiment of FIG. 3, conversion/extraction zone 200B may comprise a warm gas clean up system 22. In other embodiments, high pressure synthesis gas obtaining zone 100 comprises a WGCU system 22. WGCU system 22 may be positioned downstream of a shift reactor, for example, downstream of a first shift reactor 40A, as depicted in FIG. 3. WGCU system 22 may be designed to spray an absorber solution into a sour gas stream introduced thereto and convert H₂S into sulfur, or otherwise capture the sulfur component of the gas.

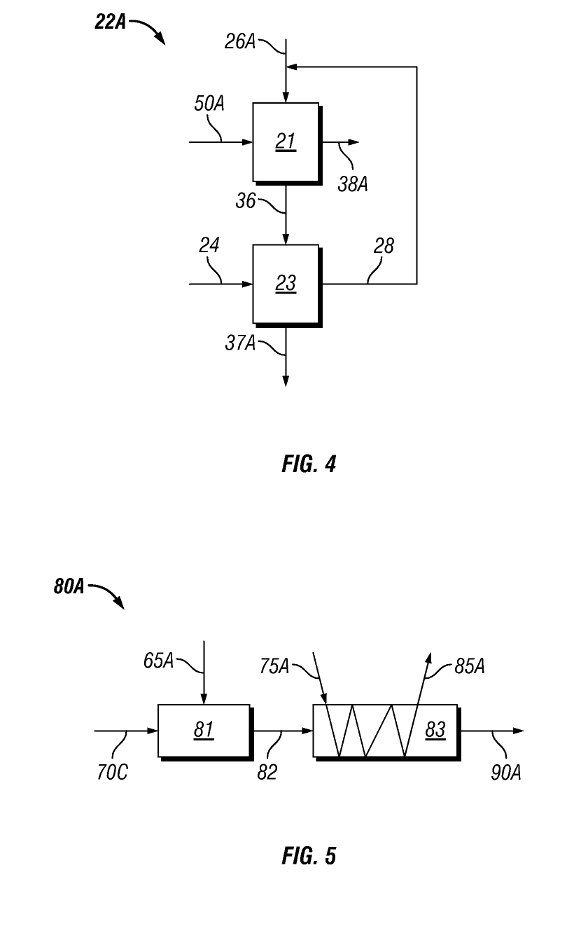

FIG. 4 is a schematic of an embodiment of WGCU system 22A. In this embodiment, WGCU system 22A comprises absorber 21 and regeneration vessel 23 connected by regeneration line 36. Absorber 21 may be a sour gas absorber. Line 36 connects absorber 21 with regeneration vessel 23, whereby spent solution may be introduced into regeneration vessel 23. Regeneration vessel 23 is adapted for regenerating spent solution from absorber 21 by contacting the spent solution with air or oxygen. Oxidant line 24 is adapted for introduction of air or oxygen into WGCU system 22A. A vent from the regeneration vessel 23 may release unused air or oxygen to the environment; or such a vent may be ducted to an associated air separation unit (ASU). Line 37 is connected with regeneration vessel 23 for extraction of sulfur in wet form or acid solution from WGCU system 22A. Line 28 connects WGCU absorber 21 with a source of fresh solution and WGCU solution inlet line 26A is connected via recycle line 28 with regeneration vessel 23, whereby regenerated solution may be pumped from regeneration vessel 23 back to sour gas absorber 21. WGCU system 22 may be designed such that the amount of H₂S removed by WGCU system 22 is determined by the sulfur tolerance of any downstream hydrogen separation membranes, e.g. downstream hydrogen separation units 60A, 60B. In embodiments, WGCU system 22 is adapted to provide a product synthesis gas extracted via line 38 comprising an H₂S concentration in the range of from about 10 ppm to about 100 ppm.

It is noteworthy that a WGCU system differs markedly from a traditional acid gas removal unit or AGR. WGCU 22 is configured such that product gases such as H₂ or CO₂ do not leave the main flow path, but rather continue on via line 38. Only the absorbent liquid solution and sulfur species leave the main flow path by line 36. In a traditional AGR system, both the sulfur species and the CO₂ would exit the main flow path, with two subsequent heating and flash stages utilized to remove H₂S and CO₂. The resulting CO₂ would generally be at a very low pressure, e.g. 3 psig (122 kPa), regardless of the original synthesis gas pressure, and a CO₂ compressor would be needed to recompress the gas for EOR or other purposes. A separate sulfur treatment system would also be required, in some instances, to treat the H₂S. The high pressure processing system of this disclosure thus does not comprise an AGR unit.

### Oxidation Zone 300

### Oxy-Fuel System 80

The disclosed high pressure synthesis gas processing system also comprises an oxidation zone 300 downstream of the conversion/extraction zone 200. As discussed hereinabove, hydrogen separation unit 60, 60A, 60B is configured to produce a hydrogen-lean or “hydrogen-depleted” tailgas product. Operation of hydrogen separation unit 60, 60A, 60B will generally provide hydrogen-lean product containing a small amount of hydrogen. The hydrogen-lean product may also comprise a small amount of unshifted CO. Any methane or other higher hydrocarbons from the raw synthesis gas may still remain in the hydrogen-lean product. Desirably, hydrogen-lean product comprises, on a volumetric percentage basis, a majority of carbon dioxide. However, the CO₂ concentration may still be below that which would be desirable for an EOR gas used in miscible oil recovery applications, for example. Moreover, remaining energy-containing contaminants in the hydrogen-lean tail gas would be counterproductive to the overall process, and there may remain significant chemical energy in the hydrogen-lean tailgas. Therefore, at least a portion of this energy is recovered, improving the overall thermal efficiency of the high pressure synthesis gas processing system. In applications, most of this energy is recovered.

High pressure synthesis gas processing system 10 thus also comprises oxidation zone 300 designed for removal of a majority of the methane, hydrogen, carbon monoxide, and nitrogen (N₂) remaining in the hydrogen-lean tailgas. As mentioned hereinabove with regard to the critical temperature data provided in Table 1, such compounds are undesirable EOR compounds. Oxidation zone 300A comprises oxy-fuel burner system 80 (also referred to herein as “oxy-fuel system 80”).

System 10 comprises hydrogen-lean outlet line 70 whereby hydrogen-lean tailgas product of hydrogen separation unit 60 from conversion/extraction zone 200A is introduced into oxy-fuel burner system 80 of oxidation zone 300A. Oxy-fuel burner system 80 is configured for oxidizing the hydrogen lean tailgas with purified oxygen. Purified oxygen is introduced into a burner of oxy-fuel burner system 80 via oxygen inlet line 65. The oxy-fuel burner of oxy-fuel system 80 is adapted for conversion of a majority of any methane, hydrogen, carbon monoxide, sulfur and nitrogen, present in the hydrogen-lean tailgas to EOR-desirable compounds. Water vapor may be produced (from, for example, any methane and hydrogen remaining in the hydrogen-lean tailgas), CO₂ (from, for example, any methane and carbon monoxide remaining in the hydrogen-lean tailgas), sulfur-dioxide compounds (from, for example, any H₂S and COS in the hydrogen-lean tailgas) and nitrogen oxide compounds (from, for example, any N₂, NH₃, and/or HCN in the hydrogen-lean tailgas). Oxy-fuel burner system 80 comprises any apparatus suitable for oxidation of the hydrogen-lean tailgas. In embodiments, oxy-fuel system 80 comprises an oxy-fuel boiler, a thermal oxidizer, or a purpose-built unit similar to an oxygen-fired partial oxidation reactor (POX) which is designed to withstand the high pressures for which system 10 is intended.

In embodiments, oxy-fuel burner system 80 comprises a high pressure oxidizer, similar to a POX reactor, designed with built-in steam-generation features to cool the process gas. In such embodiments, as depicted in FIG. 2, feedwater (or other coolant) is introduced into oxy-fuel system 80 via feedwater (or other coolant) inlet line 75 and steam produced in the built-in steam generator may be extracted from oxy-fuel system 80 via steam discharge line 85. FIG. 5 is a schematic of another embodiment of an oxy-fuel burner system 80A suitable for use in oxidation zone 300. In the embodiment of FIG. 5, oxy-fuel burner system 80A comprises an oxidizer 81 and a downstream steam generator 83. In such embodiments, oxidizer 81 may be selected from oxy-fuel boilers, thermal oxidizers, and purpose-built units similar to oxygen-fired partial oxidation reactors (POX) and designed to withstand the high pressures for which system 10 is intended. In such embodiments, hydrogen-lean outlet line 70C connects conversion/extraction zone 200 with oxidizer 81. Oxygen inlet line 65A is connected with oxidizer 81 for introduction of oxygen thereto. A line 82 connects oxidizer 81 with downstream steam generator 83. Feedwater (or other coolant) inlet line 75A connects steam generator 83 with a cooling water (or other coolant) supply, and steam is extracted from steam generator 83 via steam discharge line 85A. Oxidized product gas exits oxy-fuel system 80A via oxidized product outlet line 90A. In other embodiments, steam generation occurs within the oxidizer via an internal steam generator as well as downstream via an external steam generator. The recovered heat may be utilized throughout system 10 for feed water heating, and other waste heat recovery or regenerative heating.

Oxy-fuel burner system 80, 80A utilizes oxygen. An air separation unit may be connected with oxy-fuel system 80, 80A. Such an air separation unit should be capable of providing reasonably pure oxygen, e.g. oxygen having a purity of greater than or equal to 90-95% purity. A limited amount of nitrogen contamination in the oxygen is accepted. Oxygen expense increases with increasing purity; but the cost of a purity of 99.5% is generally not considered unreasonable. The oxidizer of oxy-fuel system 80, 80A is preferably operable at very high temperatures via judicious use of oxygen while not creating excess residual oxygen, which would negatively affect EOR gas due to excess oxygen contamination. Oxygen specification could limit EOR gas concentration to less than 10 ppmv oxygen. It is thus desirable that oxy-fuel system 80 be operable to produce minimal amounts of excess oxygen.

The temperature of operation of oxy-fuel burner of oxy-fuel system 80 is preferably such that nitrogen contaminants in the hydrogen-lean tailgas and in the oxygen sources react with oxygen, ensuring substantially complete oxidation to nitrogen oxides, preferably as NO₂. When present in moderate amounts, NO₂ may be considered a “good” EOR gas. N₂, however, is generally undesirable, with typical EOR specifications limiting N₂ content to less than 4%. Oxy-fuel burner of oxy-fuel system 80, 80A preferably reduces N₂ such that the resultant EOR gas extracted from system 10 has a N₂ concentration of less than about 4%.

Oxidation within the oxy-fuel burner should also be operable at temperature at which most sulfur compounds in the hydrogen-lean tailgas are transformed to SO₂. In moderate amounts, as indicated in Table 1, SO₂ is a “good” EOR gas. (H₂S is also a good EOR gas, but it is more hazardous at certain concentrations than the other compounds described herein, and is therefore undesirable in the product EOR gas, particularly if it can be readily oxidized to SO₂ within oxy-fuel system 80, 80A. Typical CO₂ specifications limit H₂S concentration to within the range of from about 10 ppmv to 200 ppmv.)

### High Pressure Product Enhancement/Utilization Zone 400

The disclosed high pressure synthesis gas processing system may further comprise a high pressure product enhancement/utilization zone 400. In certain applications, high pressure product enhancement/utilization zone 400 comprises at least one contaminant removal unit. The at least one contaminant removal unit may be adapted to remove at least one selected from the group consisting of sulfur compounds, nitrogen compounds, mercury, and heavy metals, from the oxidized product gas produced in oxidation zone 300. The at least one contaminant removal unit may comprise at least one selected from the group consisting of zeolite beds and activated carbon beds.

In embodiments, high pressure product enhancement/utilization zone 400 comprises apparatus for contacting oxidized product gas in oxidized product gas outlet line 90 with at least one absorbent to assist in removal of at least one selected from water-soluble gases including nitrogen compounds and sulfur compounds and water-soluble salts or compounds from remaining gas. The remaining gas may be introduced into apparatus adapted for transforming non-soluble mercury therein into soluble mercury.

### Preparation of High Pressure CO₂Rich Product Gas for Use in Sequestration

FIG. 2 shows an embodiment of a high pressure product enhancement/utilization zone 400A. In this embodiment, high pressure product enhancement/utilization zone 400A comprises a cooling and/or dehydration apparatus 110 and a pump or compressor 125.

High pressure product enhancement/utilization zone 400A of high pressure synthesis gas processing system 10 comprises cooling and/or dehydration apparatus 110 positioned within. In this embodiment, cooling and/or dehydration apparatus 110 is positioned downstream of oxy-fuel burner system 80 and adapted to remove water from the oxidized product gas extracted from oxy-fuel burner system 80 via oxidized product gas outlet line 90.

The oxidizer unit of oxy-fuel burner system 80 may produce an oxidized product gas comprising a level of water vapor above that desired for a gas to be used for sequestration. The typical maximum water content of EOR pipeline gas is 30 pounds of water per million standard cubic feet of gas. Water vapor may thus be removed from the oxidized product gas via cooling and/or dehydration apparatus 110. Cooling and/or dehydration apparatus 110 may be operable to remove water vapor from the oxidized product gas via cooling, dehydration, or a combination thereof. Lines 105 and 115 are configured to introduce heat transfer fluid such as chilled water and/or cooling tower water from a chiller or heat sink. Water removal line 95 provides for water condensate removal. Lines 105 and 115 may alternatively carry desiccant solutions, such as but not limited to various glycols; in such a case, the desiccant may be regenerated via a regeneration system.

Within cooling/dehydration apparatus 110, soluble gases, such as SO₂, may dissolve in the liquid water, producing acid. SO₂ may also form sulfuric acid when in the presence of NO₂. The same may be said of nitrogen compounds which are likely to dissolve in the liquid water. Accordingly, cooling and/or dehydration apparatus 110 may utilize chemical reagents typical of coal exhaust scrubbing for absorption of these constituents and neutralization of the liquid water.

In embodiments, cooling and/or dehydration apparatus 110 is operable to remove water vapor from the oxidized product gas such that the remaining water vapor remains under-saturated at plausible low temperature conditions that might be experienced in a pipeline, including conditions at both lower and higher pipeline pressures than the pressure at the end of system 10. Similarly, cooling and/or dehydration apparatus 110 may be operable to reduce the water vapor within the oxidized product gas from oxidation zone 300 such that hydrate formation is unlikely. For example, the desired water vapor content may be less than a maximum water vapor content. In embodiments, the maximum water vapor content is about 30 pounds per million cubic feet. In embodiments, cooling and/or dehydration apparatus 110 is fluidly connected with a dehydrated product outlet line 120 and provides a sequestration gas comprising greater than or equal to about 95% CO₂ by volume.

High pressure product enhancement/utilization zone 400A of the high pressure synthesis gas processing system 10 comprises one or more pumps 125, positioned downstream of oxidation zone 300A. Should the residual pressure of the oxidized product gas be below a desired value, one or more pumps or compressors 125 may be utilized to increase the pressure therein. For example, if the residual pressure P2 of supercritical product CO₂-rich gas exiting oxy-fuel system 80 or the residual pressure P2′ of CO₂-rich dehydrated product gas in dehydrated product outlet line 120 is less than a desired value, system 10 may further comprise one or more pumps or compressors 125 for increasing the pressure of the CO₂-rich product gas. Increased pressure CO₂-rich product gas may be extracted from pump or compressor 125 via increased pressure product outlet line 130. Because the CO₂-rich product gas will be supercritical, raising the pressure thereof will be more akin to pumping, as compared to compressing with a gas compressor. This is because the supercritical CO₂-rich product gas is in a “dense phase” condition, with properties more similar to a fluid than to a gas. Such a pressurization step using a dense-phase pump may involve use of less expensive capital equipment and reduced operational expense as compared with pressurizing a non-supercritical gas.

Should the residual end pressure P2 of the oxidized gas extracted via oxidized product gas outlet line 90 be less than its supercritical pressure, but still at reasonably high pressure, system 10 may comprise a cooling apparatus to cool the gas to a temperature below the saturation temperature at that pressure. The cooling apparatus may operable to condense the product to a liquid state, in which the CO₂-rich product may be pumped to higher pressure, instead of using a more traditional gas compressor.

In some embodiments, pump or compressor 125 may comprise a compressor, rather than a pump or a dense-phase pump. Such a compressor 125 may operate with a much lower pressure ratio, pressurizing from a reasonably high starting pressure P2 exiting oxy-fuel burner system 80. In embodiments, compressor 125 is a single stage compressor, which is considerably less expensive than a typical multi-stage intercooled compressor. Preferably, the high pressure synthesis gas processing system comprises no compressors, as the resultant CO₂-rich product gas is formed above the critical pressure of CO₂.

### Utilization of High Pressure CO₂-Rich Product Gas to Produce Mechanical Energy

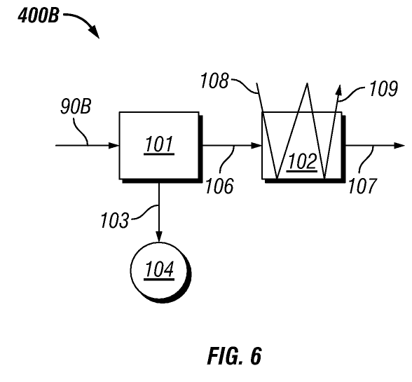

FIG. 6 is a schematic of an embodiment of a high pressure product enhancement/utilization zone 400B. In this embodiment, high pressure product enhancement/utilization zone 400B comprises a mechanical expander 101 adapted to “let-down”, i.e. depressurize or expand the hot, high-pressure oxidized gas product exiting oxidation zone 300. Mechanical expander 101 is connected to a generator or other mechanical device 104, for example, via mechanical transmission device 103. In this manner, the gas pressure may be reduced to atmospheric pressure, with the recovery of mechanical energy. A Heat Recovery Steam Generator (HRSG) 102 is coupled to mechanical expander 101 via a line 106, such that any heat remaining in the expended low pressure product exiting mechanical expander 101 via line 106 may be recovered. Cooling fluid, e.g. water, is introduced to HRSG 102 via HRSG coolant inlet line 108 and steam or heated fluid extracted from HRSG 102 via HRSG coolant outlet line 109. HRSG outlet line 107 could connect HRSG 102 with a chimney such that the resulting low pressure gas therein may be vented to atmosphere. Alternatively or additionally, high pressure product gas enhancement/utilization zone 400 may comprise additional clean-up apparatus connected with HRSG 102 for removal of sulfur and nitrogen compounds by any of many known methods available for such gas clean-up, before venting to atmosphere.

In embodiments wherein sequestration gas is to be produced along with hydrogen-rich product, such a mechanical expander is undesirable, as a high pressure EOR gas may be preferable. In such instances utilizing a mechanical expander, the low pressure expanded product gas would need to be re-compressed to a desired pressure should downstream utilization of the product gas for sequestration purposes be desired. Such re-compression may be costly. Preferably, therefore, an embodiment as indicated in FIG. 2 is utilized, with energy recovery from the oxidizer provided via steam generation.

### II. Process

Referring now to FIGS. 2 and 3, an embodiment of a process for processing high pressure synthesis gas will now be described. As depicted in FIG. 2 (FIG. 3), inlet line 30 (inlet line 30A) provides raw, high-pressure synthesis gas having a pressure P1 to conversion/extraction zone 200 (conversion/extraction zone 200A). The raw high pressure synthesis gas may be obtained from high pressure synthesis gas obtaining zone 100 (100A), which may or may not be part of the disclosed high pressure synthesis gas processing system. The raw high pressure synthesis gas introduced via inlet line 30 (30A) may be produced via gasification in a gasification system 5, for example, via underground coal gasification using very deep coal. The raw synthesis gas may have a mole ration of hydrogen to carbon monoxide in the range of from about 1:2 to about 2:1. In applications, the raw synthesis gas has a mole ratio of hydrogen to carbon monoxide of about 1:1. In embodiments, the raw synthesis gas comprises from about 40-46% hydrogen by volume, from about 40-46% CO by volume, less than about 5% CO₂ by volume, and less than about 10% H₂O by volume. P1 may be equal to a desired value of residual pressure P2, P2′ of the CO₂-rich product produced via the disclosed system plus the sum of the pressure drops along the process train. The desired value may be the critical pressure of CO₂; the minimum miscibility pressure of an oil to be extracted with the CO₂-rich product gas having residual pressure P2, P2′; or a desired CO₂ transport pipeline pressure.

The raw high pressure synthesis gas produced via gasification system 5 may be cleaned of gross contamination such as particulates and liquids by a gas cleaning or quench apparatus 20. Quench water is introduced into cleaning or quench apparatus 20 via quench water supply line 25 and wastewater removed from gas cleaning or quench apparatus 20 via wastewater outlet line 35. In embodiments, gas cleaning or quench apparatus 20 is used to quench the high pressure synthesis gas produced in gasification system 5 to a temperature suitable for introduction into shift reactor 40. Quenched product is transported via inlet line 30 (first shift reactor inlet line 30A in FIG. 3) to shift reactor 40 (first shift reactor 40A in the embodiment of FIG. 3).

As shown in the embodiment of FIG. 2, high pressure synthesis gas is introduced via inlet line 30 into steam shift reactor 40, which is shown as a single unit, but may comprise several reaction beds and heat exchangers. Within steam shift reactor 40, water and/or steam introduced via steam inlet line 45 and carbon monoxide in the synthesis gas is converted via the water-gas shift reaction represented by Eq. (1) to additional hydrogen and carbon dioxide, producing hydrogen-rich synthesis gas.

Hydrogen-rich synthesis gas is removed from shift reactor 40 via shifted product outlet line 50. The hydrogen-rich synthesis gas is introduced into hydrogen separation unit 60. Within hydrogen separation unit 60, the hydrogen-rich synthesis gas is separated into a hydrogen-rich product comprising a greater percentage of hydrogen than the hydrogen-rich synthesis gas and a hydrogen-lean product comprising a lower percentage of hydrogen than the hydrogen-rich synthesis gas. Hydrogen-rich product is removed from hydrogen separation unit 60 via hydrogen-rich outlet line 55, and may used for power generation or industrial/chemical uses or delivered to a hydrogen pipeline. Hydrogen-lean tail gas rich in carbon dioxide is extracted via hydrogen-lean outlet line 70.

As shown in the embodiment of FIG. 3, high pressure synthesis gas may be introduced via first shift reactor inlet line 30A into first steam shift reactor 40A. Within first steam shift reactor 40A, steam introduced via steam inlet line 45A and carbon monoxide in the synthesis gas is converted via the water-gas shift reaction represented by Eq. (1) to additional hydrogen and carbon dioxide, producing hydrogen-rich synthesis gas. As shown in the embodiment of FIG. 3, a first shifted synthesis gas product may be introduced via first shifted synthesis gas outlet line 50A into WGCU system 22. In WGCU system 22, an absorber solution is sprayed into the sour gas stream, to convert H₂S into sulfur, or otherwise capture the sulfur component of the gas. As depicted in FIG. 4, suitable liquid solution is introduced into absorber 21 by WGCU solution inlet line 26A. Spent solution is introduced into regeneration vessel 23 via line 36. The solution is regenerated in regeneration vessel 23 by contact with air or oxygen introduced into WGCU system 22 via oxidant line 24. Sulfur is produced in a wet form or acid solution and exits WGCU system 22 via line 37A. Regenerated solution is pumped from regeneration vessel 23 through line 28 back to sour gas absorber 21. The amount of H₂S removed in WGCU system 22 may be determined by the sulfur tolerance of any downstream hydrogen separation membranes, e.g. downstream second hydrogen separation unit 60A. Typically, WGCU system 22 will provide a product synthesis gas comprising an H₂S concentration in the range of from about 10 ppm to about 100 ppm.

The hydrogen-rich synthesis gas exits the WGCU absorber by line 38, and is introduced into first hydrogen separation unit 60A. Here the majority of the hydrogen, typically up to 80-90%, is removed from the synthesis gas and extracted from conversion/extraction zone 200B via first hydrogen-rich outlet line 55A. The tail gas extracted from first hydrogen separation unit 60A via first hydrogen-lean outlet line 70A of may still comprise unreacted entrained CO.

Hydrogen-lean tail gas extracted in first hydrogen-lean outlet line 70A enters the second shift reactor 40B. This tail gas in first hydrogen-lean outlet line 70A may be re-humidified with water and/or steam from steam inlet line 45B before entering second shift reactor 40B. Because of the lower H₂S content of the tailgas, the second shift reactor may be of either the sour shift variety, or the sweet shift variety, depending on remaining H₂S. The majority, typically 80-90%, of the remaining CO is converted to H₂ and CO₂. The remaining tail gas exits through second shifted synthesis gas outlet line 50B.

Tail gas in second shifted synthesis gas outlet line 50B enters second hydrogen separation unit 60B where the majority of the remaining hydrogen, typically up to 80-90%, is removed. The hydrogen-depleted syngas exits by second hydrogen-lean outlet line 70B.

In the shift reactor(s), the majority of the CO, typically up to 80-90%, will be converted by reaction with H₂O to CO₂ and H₂. COS will be converted to H₂S. In embodiments, the hydrogen-rich synthesis gas produced in the shift reactor(s) comprises less than about 20% by volume of the amount of CO in the raw synthesis gas feed. In embodiments, the hydrogen-rich synthesis gas produced in shift reactor(s) 40, 40A, 40B comprises less than about 15% by volume of the amount of CO in the raw synthesis gas feed. In embodiments, the hydrogen-rich synthesis gas produced in shift reactor 40, 40A, 40B comprises less than about 10% by volume of the amount of CO in the raw synthesis gas feed. In embodiments, the hydrogen-rich synthesis gas comprises at least about 50% by volume hydrogen; alternatively, at least about 55% by volume hydrogen; alternatively, at least about 60% by volume hydrogen.

In applications, at least about 80% by volume of the hydrogen in the hydrogen-rich synthesis gas fed into hydrogen separation unit 60, 60A, 60B is removed via hydrogen-rich outlet line 55, 55A, 55B, respectively. In applications, at least about 85% by volume of the hydrogen in the hydrogen-rich synthesis gas fed into hydrogen separation unit 60, 60A, 60B is removed via hydrogen-rich outlet line 55, 55A, 55B. In applications, at least about 90% by volume of the hydrogen in the hydrogen-rich synthesis gas fed into hydrogen separation unit 60, 60A, 60B is removed via hydrogen-rich outlet line 55, 55A, 55B.

As mentioned hereinabove, combined units capable of shifting CO and steam to CO₂ and H₂ and separating hydrogen from the product may be utilized in some applications. The hydrogen-rich product removed from hydrogen separation unit 60, 60A, 60B may comprise at least about 90% pure hydrogen by volume; alternatively, the hydrogen-rich product may comprise at least about 95% pure hydrogen; alternatively, at least about 98% pure hydrogen; alternatively, at least about 99.9% pure hydrogen. In embodiments, the hydrogen-rich product extracted from hydrogen separation unit 60, 60A, 60B via hydrogen-rich outlet line 55, 55A, 55B has a pressure of greater than about 400 psi (2.8 MPa); alternatively, greater than about 500 psi (3.4 MPa). In some applications, the hydrogen-rich product extracted from hydrogen separation unit 60, 60A, 60B via hydrogen-rich outlet line 55, 55A, 55B has a pressure of greater than about 800 psi (5.5 MPa); alternatively, greater than about 900 psi (6.2 MPa); alternatively, greater than about 1,000 psi (6.9 MPa). Desirably, the residual hydrogen pressure of the hydrogen-rich product is greater than hydrogen pipeline pressure.

If desired, the hydrogen-rich product extracted from the hydrogen separation unit may be further polished, for example, for removal of entrained moisture and/or H₂S therefrom. Such polishing may be performed by any methods known in the art, for example hydrogen PSA, guard beds of ZnO or similar adsorbents and molecular sieves. The hydrogen-rich product may be sold or utilized onsite for power generation.

The hydrogen-depleted tail-gas exiting conversion/extraction zone 200 via hydrogen-lean outlet line 70 (second hydrogen-lean outlet line 70B in the embodiment of FIG. 3) comprises mostly CO₂ and steam, and may also comprise minor amounts of CO, H₂, H₂S, and various nitrogen compounds. Hydrogen-depleted tail-gas in hydrogen-lean outlet line 70, second hydrogen-lean outlet line 70B may comprise at least about 65% CO₂ and steam by volume; alternatively, at least about 70% CO₂ and steam by volume; alternatively, at least about 75% CO₂ and steam by volume. The hydrogen-depleted tail gas from conversion/extraction zone 200 is introduced into oxidation zone 300. For example, as indicated in FIG. 2, hydrogen-depleted tailgas in hydrogen-lean outlet line 70 is introduced into an oxygen-fired oxidizer or oxy-fuel burner system 80. Within oxy-fuel burner system 80, any remaining hydrogen, methane, carbon monoxide, hydrogen sulfide, nitrogen, and other undesirable compounds are oxidized to compounds including, but not limited to, water, carbon dioxide, sulfur dioxide, and nitrogen dioxide. Undesirable CO and H₂ remaining in hydrogen-lean tailgas may be converted to desirable CO₂ and condensable H₂O respectively. Undesirable H₂S and other sulfur compounds are converted to desirable (with respect to use as EOR) SOx. Molecular nitrogen, which is an undesirable component in an EOR gas is converted to NOx as are any other undesirable nitrogen contaminants such as NH₃ and HCN in the hydrogen-lean tailgas.

Purified oxygen is introduced into oxy-fuel burner system 80 via oxygen inlet line 65 from, for example an air separation unit. In embodiments, the oxygen utilized in oxidation is at least about 95% pure; alternatively, at least about 98% pure; alternatively, at least about 99% pure; alternatively, at least about 99.5% pure. The use of oxygen in the oxidation zone 300 may be minimized, to control operational expenses and exceed a desired O₂ limit in the CO₂-rich product gas exiting high pressure system 10. A subjective balance may be struck between incomplete oxidation of undesirable compounds within oxy-fuel system 80 and the presence of O₂ in the CO₂-rich product gas in excess of a desired amount, e.g. above pipeline purity specifications. The oxygen required for this process may be only a fraction of that typically required in gasification processes that utilize oxygen.

Heat generated by oxidation in oxy-fuel system 80 may be converted to steam, either within oxy-fuel system 80, and/or in a dedicated heat recovery system which is part of the oxy-fuel system 80. For example, in the embodiment of FIG. 2, heat is produced in oxy-fuel system 80 and converted therein to steam, which is discharged via steam discharge line 85 (although described as “steam” discharge line, it is envisioned that line 85 could be a discharge line for another heated transfer fluid). In the embodiment of FIG. 5, hydrogen-lean product and oxygen are introduced into oxidizer 81 via hydrogen-lean outlet line 70C and oxygen inlet line 65A respectively. Hot oxidized product is extracted from oxidizer 81 via line 82 and introduced into downstream steam generator 83, e.g., a heat exchanger, wherein the heat from oxidation is transferred from the hot oxidized gas to coolant. Coolant is introduced via coolant or feedwater inlet line 75A and pass through coils within steam generator 83. Heated coolant, e.g. steam, is extracted from steam generator 83 via steam discharge line 85A.

Cooled oxidized product is extracted from oxidation zone 300 via oxidized product gas outlet line 90, and may be introduced into high pressure product enhancement/utilization zone 400. Cooled oxidized CO₂-rich product gas in oxidized product gas outlet line 90 may still have too high a temperature for pipeline service and may also contain too much water vapor. Therefore, in embodiments, cooled oxidized CO₂-rich product gas exiting oxidation zone 300 is introduced into a cooling and/or dehydration system 110 (also referred to herein as “cooling/dehydration apparatus 110”) of high pressure product enhancement/utilization zone 400.

A cool heat transfer fluid, such as chilled water and/or cooling tower water, may be introduced into cooling and/or dehydration system 110 via lines 105 and/or 115. Condensed water is extracted from cooling and/or dehydration system 110 via water removal line 95. Alternatively or additionally, a desiccant may be introduced via lines 105 and/or 115. Such a desiccant may be, for example, selected from glycols. In such applications, a desiccant regeneration system may be utilized to regenerate spent desiccant.

Within cooling and/or dehydration system 110, soluble gases, such as SO₂, are dissolved in the liquid water, producing acid. SO₂ may also form sulfuric acid when in the presence of NO₂. Similarly, nitrogen compounds may dissolve in the liquid water. Accordingly, chemical reagents typical of coal exhaust scrubbing may be utilized within cooling/dehydration apparatus 110 for absorption of these constituents and neutralization of the liquid water extracted e.g., as condensate, via water removal line 95. In applications, water vapor is removed to a level at which the water vapor pressure in the EOR gas does not lead to condensation of liquid water at or below a bulk EOR gas temperature of 32° F. (0° C.).

Cool, dry CO₂-rich product gas is removed from cooling and/or dehydration system 110 by dehydrated product outlet line 120. CO₂-rich product gas comprises primarily CO₂ and may comprise less than about 0.5% by volume H₂, less than about 0.5% by volume CO, and less than 3 aggregate percent by volume SOx and NOx. In embodiments, the CO₂-rich product gas in dehydrated product outlet line 120 meets the purity specifications of CO₂ pipelines. The CO₂-rich product gas may comprise at least 95% by volume CO₂; alternatively, at least about 96% CO₂; alternatively, at least about 98% CO₂. In embodiments, the O₂ concentration in the CO₂-rich product gas is less than about 10 ppmv. In embodiments, the N₂ concentration in the CO₂-rich product gas is less than 4%; alternatively, less than about 3%; alternatively, less than about 2%; or alternatively, less than about 1%. CO₂-rich product gas may comprise up to about 3% by volume SOx and NOx, which offers the potential to improve the performance of the CO₂-rich product gas as an EOR gas over that of an EOR gas comprising 3 additional percent CO₂ rather than 3 aggregate percent SOx and NOx.

If necessary, sulfur and nitrogen contaminants may be removed from the CO₂-rich product gas by methods known in the industry, including but not limited to chemical reduction processes using hydrogen, and chemical oxidizing processes using oxygen, as the bulk CO₂-rich product gas in dehydrated product outlet line 120 is no longer chemically reducing in nature. Any remaining mercury contamination could be removed through carbon beds or other commercially acceptable means of mercury capture, if desired.

The CO₂-rich product gas has a residual pressure P2, P2′. The residual pressure of the CO₂-rich product gas is greater than the critical pressure of CO₂, which is about 1,070 psi (7.4 MPa). By starting with a high-pressure raw synthesis gas having a pressure P1 and controlling the loss of pressure throughout the processing train, the CO₂-rich product gas is produced at a residual pressure greater than the critical pressure of CO₂. The displacement efficiency of stranded oil by CO₂ is dependent on pressure. Miscible displacement efficiency occurs only at pressures above a minimum miscibility pressure, which is a function of injection gas composition. A typical minimum miscibility pressure of pure CO₂ in oil is 1,175 psi (8.2 MPa). Preferably, the CO₂-rich product gas produced in the high pressure system 10 has a residual pressure of greater than about 1,500 psi (10.3 MPa), a typical gas injection pressure, which will typically exceed the minimum miscibility pressure in oil in many EOR applications. This higher pressure also exceeds the critical pressures of SO₂ (1,143 psi; 7.9 MPa) and NO₂ (1,470 psi; 10.1 MPa). In some applications, the CO₂-rich product gas has a residual pressure of greater than about 2,200 psi (15.2 MPa), which is a typical pressure rating for long-distance CO₂ pipelines. The CO₂-rich product gas may be introduced into a CO₂ pipeline.

The pressure P1 of the raw synthesis gas at the beginning of the process should be higher than the sum of the critical pressure of CO₂ (1,070 psi; 7.4 MPa) plus a margin for pressure drop along the entire processing scheme. In this manner, the residual pressure P2 of the CO₂-rich product gas in oxidized product gas outlet line 90 or the residual pressure P2′ of dehydrated product outlet line 120 may be above critical pressure of CO₂. In other embodiments, the pressure P1 of the raw synthesis gas and the steps in the process train are selected such that the pressure of the resulting CO₂-rich product gas is greater than a desired value that is above the critical pressure of CO₂. For example, the desired value may be the minimum miscibility pressure of oil to be extracted via enhanced oil recovery operations with the CO₂-rich product gas. In embodiments, the desired value is a value greater than a transport pipeline operating pressure, for example, which may be about 2,200 psi (15.2 MPa). In embodiments, the raw synthesis gas has a pressure P1 of at least about 2,000 psi (13.8 MPa) and the CO₂-rich product gas has a residual pressure P2, P2′ greater than 1,500 psi (10.3 MPa). In embodiments, the raw synthesis gas has a pressure P1 of at least about 2,500 psi (17.2 MPa) and the residual pressure P2, P2′ of the CO₂-rich product gas is greater than about 2,200 psi (15.2 MPa). In embodiments, the raw synthesis gas has a pressure P1 of about 3,000 psi (20.8 MPa) and the residual pressure P2, P2′ of the CO₂-rich product gas is greater than about 2,200 psi (15.2 MPa).

Should the residual end pressure P2 or P2′ of the CO₂-rich product gas be less than its supercritical pressure, but still at reasonably high pressures, the CO₂-rich product gas may be cooled to a temperature below the saturation temperature of the corresponding pressure. In this manner, the product may be condensed to a liquid state in which the product may be pumped by one or more pumps 125 to a desired pressure. This may be economically desirable over the use of a more expensive gas compressor.

Embodiments of the disclosed processes for the production of CO₂-rich product gas suitable for use as an EOR gas offer the potential to exceed 90% carbon capture; alternatively, exceed 99% carbon capture; alternatively, exceed 99.9% carbon capture.

As shown in FIG. 6, in applications, oxidized product gas in oxidized product gas outlet line 90B is introduced into a mechanical expander 101 connected to a generator or other mechanical device 104. In this manner, the pressure of the oxidized product gas may be reduced to atmospheric with concomitant production of mechanical energy via generator 104. Heat remaining in the pressure-reduced oxidized gas may be recovered by introducing the pressure-reduced oxidized gas into a heat recovery steam generator (HRSG) 102 via line 106. Within HRSG 102, heat is transferred from the hot oxidized product gas to a coolant introduced into HRSG 102 via HRSG coolant inlet line 108. Heated product, e.g. steam, may be removed via HRSG coolant outlet line 109. The steam may be introduced into a turbine for generation of electricity, for example. The cooled pressure-reduced oxidized product may then be vented to atmosphere, perhaps with additional cleanup. Although not the primary embodiment, such an embodiment may be economically feasible when the hydrogen-rich product extracted from hydrogen separation unit 60, 60A, 60B is the main product and production of a CO₂-rich product gas for sequestration is not desired. For example, when the high pressure synthesis gas processing system is located far from any CO₂ transport pipelines or oil fields in need of sequestration gas.

### Optional Downstream Recreation of Synthesis Gas

In another embodiment, at least a portion of the CO₂-rich product gas is used for the downstream production of synthesis gas. In such an embodiment, CO₂-rich product gas is introduced into a contaminant removal system, e.g. an oxidizing system, for the removal of contaminants therefrom. The oxidizing contaminant removal system may be, for example, a ZnO process. Following contaminant removal, the contaminant-reduced CO₂-rich product gas may be combined with hydrogen-rich product from hydrogen separation unit 60 (60A, 60B) in a shift reactor under operating conditions conducive to production of CO and water. The water may be condensed out and additional hydrogen from hydrogen-rich product in hydrogen-rich outlet line 55 (55A, 55B) added to produce synthesis gas. In this manner, cleaned-up synthesis gas may be produced in the absence of costly AGR systems. The recreated synthesis gas may be utilized as desired, for example, for the production of carbon-based fuels such as, but not limited to, synfuels, methane, methanol, syncrude, etc.

### Optional Production of NH₃

Oxygen for use in oxidation zone 300 may be provided by an air separation unit. Separation of oxygen from air will provide a source of nitrogen. In embodiments, at least a portion of the nitrogen from the air separation unit is combined with hydrogen-rich product from a hydrogen separation unit of the disclosed high pressure synthesis gas processing system to produce ammonia, which may be used to produce fertilizer or other ammonia products.

Ammonia gas may be combined with CO₂-rich product gas to produce urea, which may be sold as a solid fertilizer. In embodiments, the CO₂-rich product may be cleaned of contaminants such as trace amounts of mercury, nitrogen and/or sulfur compounds prior to production of urea therefrom.

Without further elaboration, it is believed that one skilled in the art can, using the description herein, utilize the embodiments described herein to their fullest extent. The embodiments described herein are to be construed as illustrative and not as constraining the remainder of the disclosure in any way whatsoever. While the preferred embodiments of the invention have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A system for production of a CO₂-rich product gas, the system comprising:
a steam shift reactor adapted for the production of shifted synthesis gas from a high pressure raw synthesis gas, wherein the shifted synthesis gas comprises hydrogen and carbon dioxide produced by reaction of steam with carbon monoxide in the raw synthesis gas;
a hydrogen separation unit adapted to separate the shifted synthesis gas into a hydrogen-rich product comprising a greater volume percentage of hydrogen than the shifted synthesis gas and a hydrogen-lean tailgas comprising a reduced volume percentage of hydrogen than the shifted synthesis gas;
an oxidizing unit adapted to oxidize the hydrogen-lean tailgas with purified oxygen comprising primarily oxygen, to produce an oxidized product gas comprising water vapor and carbon dioxide; and
dehydration apparatus adapted for removal of water vapor from the oxidized product gas to provide CO₂-rich product gas comprising at least 95% CO₂ by volume;
wherein the proportional critical temperature of the CO₂-rich product gas is near or greater than the critical temperature of pure CO₂.

2. The system of claim 1 not comprising an acid gas removal unit.

3. The system of claim 1 wherein the purified oxygen comprises at least 99% by volume pure oxygen.

4. The system of claim 1 wherein the CO₂-rich product gas is suitable for use in enhanced oil recovery or other CO₂ sequestration processes.

5. The system of claim 1 further comprising heat recovery apparatus whereby the heat produced in the oxidizing unit is captured by the heat recovery apparatus.

6. The system of claim 1 wherein the dehydration apparatus dehydrates by cooling the oxidized product gas and condensing the water vapor therein.

7. The system of claim 1 further comprising a hot gas clean-up or warm gas clean-up unit positioned upstream of the steam shift reactor and adapted to provide H₂S removal from the raw synthesis gas.

8. The system of claim 1 comprising a plurality of steam shift reactors and a plurality of hydrogen separation units, wherein at least one hydrogen separation unit downstream of one of the steam shift reactors is paired therewith via an intervening re-humidification unit.

9. The system of claim 1 wherein the hydrogen removal unit is integrated with the steam shift reactor.

10. The system of claim 1 wherein the oxidizing unit is selected from thermal oxidizers, and partial oxidation reactors adapted for high pressure operation.

11. The system of claim 10 wherein the partial oxidation reactor is adapted for internal steam generation.

12. The system of claim 1 further comprising a steam generation unit downstream of the oxidizing unit.

13. The system of claim 12 wherein the oxidizing unit is adapted for internal steam generation.

14. The system of claim 12 further comprising a line for introducing steam from the oxidizing unit into the steam shift reactor.

15. A system for the production of a CO₂-rich product gas suitable for use in CO₂-sequestration processes from a high pressure raw synthesis gas, the system comprising:
apparatus that is configured to remove compounds having nominal critical temperatures below the critical temperature of pure carbon dioxide and leave behind compounds having nominal critical temperatures at least as high as the critical temperature of pure carbon dioxide.

16. A method of producing CO₂-rich product gas, the method comprising:
introducing steam and a high pressure raw synthesis gas into at least one steam shift reactor to produce a shifted synthesis gas comprising a greater volume percentage of hydrogen and carbon dioxide than the raw synthesis gas, wherein the steam shift reactor comprises catalyst effective for catalyzing the production, via water-gas shift, of hydrogen and carbon dioxide from the steam and at least a portion of the carbon monoxide in the raw synthesis gas;
removing a hydrogen-rich product from the shifted synthesis gas to produce a hydrogen-lean tailgas;
oxidizing the resulting hydrogen-lean tailgas by contacting the hydrogen-lean tailgas in with purified oxygen to produce an oxidized product gas comprising primarily carbon dioxide and water vapor; and
removing water vapor from the oxidized product gas to produce CO₂-rich product gas having a proportional critical temperature near to or greater than the critical temperature of pure carbon dioxide and comprising at least 95% CO₂ by volume.

17. The method of claim 16 wherein the CO₂-rich product gas is suitable for enhanced oil recovery or other CO₂ sequestration operations.

18. The method of claim 17 wherein the CO₂-rich product gas has a pressure greater than the minimum miscibility pressure required for enhanced oil recovery.

19. The method of claim 17 wherein the CO₂-rich product gas has a pressure greater than about 2,200 psi (15.2 MPa), suitable for CO₂ transport pipelines.

20. The method of claim 16 wherein the pressure of the CO₂-rich product gas is above the critical pressure.

21. The method of claim 16 further comprising extracting thermal energy from the oxidized product gas.

22. The method of claim 16 wherein removing water vapor from the oxidized product gas comprises cooling and/or dehydrating the oxidized product gas.

23. The method of claim 16 wherein the amount of CO₂ captured via the method exceeds 90%.

24. The method of claim 16 wherein the purified oxygen is produced in an air separation reactor, providing a nitrogen-rich product gas, and further comprising producing ammonia from nitrogen-rich product gas and hydrogen removed from the shifted synthesis gas.

25. The method of claim 24 further comprising producing urea from the ammonia.

26. The method of claim 16 further comprising reacting at least a portion of the carbon dioxide in the CO₂-rich product gas and at least a portion of the hydrogen in the hydrogen-rich product in the presence of suitable shift catalyst to produce a second shifted product gas comprising carbon monoxide and steam, removing water vapor from the second shifted product, and combining with a second portion of hydrogen in the hydrogen-rich product to produce recreated synthesis gas having a desired mole ratio of hydrogen to carbon monoxide.

27. The method of claim 26 wherein the desired mole ratio is suitable for the synthesis of methane, methanol, mixed alcohols, Fischer-Tropsch (FT) liquids, or other hydrocarbons from the recreated synthesis gas.

28. A method of producing hydrogen-rich product gas and energy from high pressure raw synthesis gas, the method comprising:
introducing steam and a high pressure raw synthesis gas into at least one steam shift reactor to produce a shifted synthesis gas comprising more hydrogen and carbon dioxide than the raw synthesis gas, wherein the steam shift reactor comprises catalyst effective for catalyzing the production, via water-gas shift, of hydrogen and carbon dioxide from the steam and at least a portion of the carbon monoxide in the raw synthesis gas;
removing a hydrogen-rich product gas from the shifted synthesis gas to produce a hydrogen-lean tailgas;
oxidizing the resulting hydrogen-lean tailgas by contacting the hydrogen-lean tailgas in with purified oxygen to produce an oxidized product gas comprising primarily carbon dioxide and water vapor; and
introducing the oxidized product gas into a high-pressure gas expander coupled to a generator whereby the oxidized product gas is expanded to near atmospheric pressure and energy is recovered.

29. The method of claim 28 further comprising introducing the low pressure tail gas into an atmospheric pressure heat recovery steam generator to recover further energy from steam generation.
